(19) United States
(12) Patent Application Publication
(10) Pub. No.: US 2005/0114219 A1
(43) Pub. Date: May 26, 2005

(54) Inspection and audit process for shipped goods utilizing online global pricing system

(75) Inventor: Tarek Sultan, Kuwait (KW)

Correspondence Address: Shearman & Sterling LLP;Intellectual Property Docketing, 599 Lexington Avenue, New York, NY, 10022, US

(73) Assignee: Public Warehousing Company KSC

(21) Appl. No.: 10/997,353

(22) Filed: Nov. 24, 2004

Related U.S. Application Data
(63) Continuation of application No. 10/479,279, now abandoned.
(60) Provisional application No. 60/294,248, filed on May 31, 2001.

(51) Int. Cl. G06F 17/60

(52) U.S. Cl. 705/20; 705/1; 705/8; 705/26

(57) ABSTRACT

A customs inspection and auditing process uses an online global pricing system that is implemented over a distributed network such as the Internet. The process generally includes selecting a consignment for audit based upon certain risk selectivity criteria, obtaining prices for selected items in the consignment using the online pricing system, and using the obtained prices to create a price audit report for customs officials. The system is preferably configured to provide prices in accordance with the guidelines set forth in Article VII of the World Trade Organization (WTO) Agreement on Customs Valuation so that customs officials in member countries may use the prices to accurately assess valuation in accordance with international agreements, and thereby improve government collections of customs and tax revenues, and detect illegal activity such as industrial dumping or money laundering.

### CROSS-REFERENCE TO RELATED PATENT APPLICATIONS

This application claims the benefit of provisional application Ser. No. 60/294,248 filed May 31, 2001, and is a continuation of PCT application Serial No. PCT/US02/16991, and is a continuation of U.S. application Ser. No. 10/479,279.

### BACKGROUND OF THE INVENTION

1. Field of the Invention

The present invention relates generally to customs procedures and, more particularly, to a customs inspection and audit process for imported goods using an online global pricing system.

2. Discussion of the Background Art

It is a standard practice throughout the world to levy customs duties and taxes on imported goods. Since customs duties and taxes are typically based on the value of the goods, it is necessary to physically inspect a consignment of goods and audit the declared price thereof to ensure that proper duties and taxes are paid. The inspection and audit process is also important in preventing companies from (1) undervaluing imports to understate VAT (Value-Added Tax) and customs duty liabilities or dump products in an effort to harm local industries, (2) undervaluing exports to minimize VAT and income tax liabilities, (3) overvaluing exports to practice capital flight or money laundering, or (4) overvaluing imports (especially when customs duties are low) with the intent of lowering income tax liability and shifting tax liabilities offshore.

Customs officials have in the past attempted to verify the declared price of a consignment against previous consignments of identical or similar goods from the same country of export that are made at or about the same time as the new consignment. Very often, however, consignments meeting all of the foregoing criteria cannot be found in the customs database. In other words, it is frequently not possible for customs officials to establish a correct basis for valuation.

Even when previous consignments meeting the foregoing criteria are found, it is usually necessary to adjust the price of the previous consignment based on the commercial level and quantity of the new consignment. For example, a new shipment may be priced FOB (free on board) for a particular quantity whereas the previous shipment may have been priced FAS (free alongside ship) for a different quantity. In order to adjust for these differences, it would be necessary for customs officials to gather information from the export countries, and to contact manufacturers or exporters all over the world.

Moreover, under Article VII of the World Trade Organization (WTO) Agreement on Customs Valuation, incorporated herein by reference, customs officials cannot legally challenge a declared price without providing evidence in accordance with certain guidelines set forth in Article VII. Obtaining evidence in accordance with these guidelines is a complicated and time consuming task requiring specialized expertise and familiarity with a large number of foreign jurisdictions. Customs officials generally do not have the training, resources, experience or the global physical presence necessary to obtain evidence in this manner. Without such capabilities, customs officials are unable to enforce higher or lower levels of valuation.

While a number of companies offer price research services, typically these services are provided by local analysts who gather all of the information about a consignment from customs officials and send the information to a price gatherer in the country of export. Each price gatherer may have their own local database of previous consignments requiring individual updates, maintenance and software upgrades. These price gatherers may also contact the original seller to obtain prices; however, this often leads to “automatic confirmation” of the declared price. The entire process is time consuming and can create unacceptable delays in customs clearance. In addition, there is no effective means for ensuring that the database includes the latest data, monitoring the progress of the pricing research, or shifting resources to meet changes in demand.

According to another aspect of the invention, the inspection and audit process system may be used by private corporations to obtain an independent verification of prices of purchased goods, both past and future, with respect to domestic and imported goods. Such audits function to assist a corporation in avoiding actual or potential overpayment for goods by adjusting purchasing programs.

There thus exists a need in the art for improved customs inspection and auditing procedures for customs administrators as well as corporate clients.

### SUMMARY OF THE INVENTION

A first aspect of the present invention is generally characterized in accustoms inspection and auditing process using an online global pricing system that is implemented over a distributed network such as the Internet. The process generally includes selecting a consignment for audit based upon certain risk selectivity criteria, obtaining prices for selected items in the consignment using the online pricing system, and using the obtained prices to create a price audit report for customs officials.

A second aspect of the present invention is generally characterized in a global pricing system for use in connection with a customs inspection and audit process. The system is preferably configured to provide prices in accordance with the guidelines set forth in Article VII of the World Trade Organization (WTO) Agreement on Customs Valuation so that customs officials in member countries may use the prices to challenge the declared value of the consignment if necessary.

A third aspect of the invention provides a process and system for corporate purchasing program price research using a global pricing system.

### BRIEF DESCRIPTION OF THE DRAWINGS

The above and other features and advantages of the present invention will be further understood from the following description of the preferred embodiments thereof, taken in conjunction with the accompanying drawings wherein like reference numerals indicate like parts and wherein:

FIG. 1 is a flowchart illustrating an embodiment of a customs inspection and audit process according to the present invention;

FIG. 2 is a flowchart illustrating details of an audit selection process performed as part of the customs inspection and audit process of FIG. 1;

FIG. 3 is a flowchart illustrating details of a risk analysis performed as part of the audit selection process of FIG. 2;

FIG. 4 is a flowchart illustrating details of a price gathering process performed as part of the customs inspection and audit process of FIG. 1; and

FIG. 5 is a schematic diagram of an embodiment of a system to carry out the price gathering process of FIG. 4.

### DETAILED DESCRIPTION OF THE PREFERRED EMBODIMENT

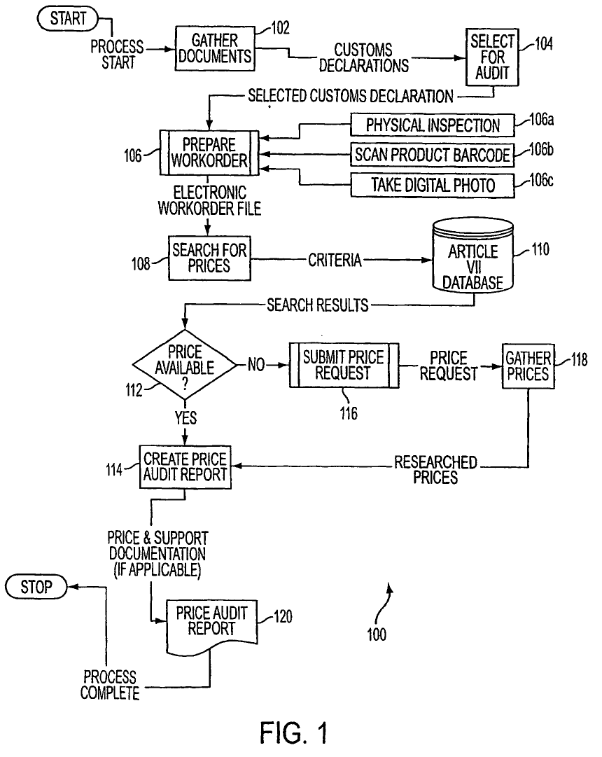

As summarized in FIG. 1, the present invention provides a customs inspection and auditing process 100 using an online global pricing system that is implemented over a distributed network such as the Internet. The process 100 generally includes selecting a consignment (e.g., a shipment of imported goods) for audit based upon certain risk selectivity criteria, obtaining prices for selected items in the consignment using the online global pricing system, and using the prices obtained thereby to create a price audit report for customs officials. The online global pricing system is preferably configured to provide prices in accordance with WTO, WCO, and GATT requirements, including the guidelines set forth in Article VII of the WTO Agreement on Customs Valuation, so that customs officials in member countries may use the prices to challenge the declared value of the consignment if necessary.

More specifically, in step 102, documents pertaining to each consignment are gathered for use in step 104 to select consignments for audit. Typically, these documents will include the shipping invoice, an inspection report, and a local customs document such as a customs declaration. The documents can be in electronic or physical format. Documents in a physical format are preferably scanned and loaded into the system as image files.

If a consignment is selected for audit in step 104, information from the documents associated with that consignment obtained by physical inspection at step 106a is used in step 106 to prepare a work order for a price audit. The work order is preferably prepared by entering relevant information into an electronic form provided on a website hosted by the pricing system. The information preferably includes a unique reference number for the consignment, the client country, the date the consignment was selected for audit, a list of the items included in the consignment, the country the items were shipped from, the final destination of the items, the mode of transport (e.g., maritime, rail, road, air, etc.), and detailed information about each of the items (e.g., a description, make, model, serial number, UPC/EAN code, packing type, origin, and the year of manufacture). The work order preferably also includes the HS-code, the quantity of each item, the FOB unit price, and the currency used.

Additionally, at step 106b a handheld barcode scanning device may be used to scan the manufacturer's UPC barcode of the selected shipment. The scanning device is Internet-enabled and accesses online databases either through standard cellular communication networks or by using other wireless communication protocols. Further, digital images of the goods selected for inspection may be obtained at step 106c. Such digital images may be attached to the manifest and shipping documents associated with the audited shipment.

The Internet-enabled scanning device thus may search online product databases in an attempt to match the scanned barcodes with associated transaction values and/or reference prices, thereby facilitating an immediate valuation assessment. Additionally, the scanning step enables the creation of a comprehensive manufacturers' UPC code database, thus facilitating product identification. Associating digital images of the inspected goods with the manifest information facilitates product identification by price gatherers, in that there currently is no uniform system for describing products, whereby identical products may be referred to differently in different shipping documents and customs declarations. Inclusion of digital images of the products aids in proper identification and valuation of the products at issue.

In step 108, information from the work order is used to generate one or more search queries that are sent via the network to an Article VII database 110 containing export level prices obtained in accordance with WTO guidelines. The query can be manually initiated by making a request on the online system or, alternatively, the system can automatically conduct a search by stripping information about the items from the work order. In either case, the database 110 is searched for a price associated with each item of the consignment. The search results are evaluated at step 112 and, if prices are available for each item, a price audit report is created at step 114 based upon the price provided by the Article VII database 110. If it is determined at step 112 that a price for any of the consignment items is not available, a price request is submitted to a price gatherer via the network at step 116. The price request will include information on the unpriced items drawn from the work order and will preferably be linked to the image files of any documents associated with the consignment so that the price gatherer will have ready access to all relevant information.

The price gathering process is conducted at step 118, and the results from the price gathering process are used to create a price audit report 120 in step 114. The price audit report is preferably presented to the client (typically customs officials) with physical copies of the documents associated with the consignment. The client can compare the researched prices against the declared prices and may use the price audit report to adjust the customs duty paid or payable by the declarant or, in exceptional cases, as a basis for referral to appropriate law enforcement agencies for further investigation. The latter may occur, for example, where the declared price or value is significantly less than the researched price since undervaluation can be indicative of an attempt to dump imported goods to the detriment of domestic industry, to engage in illegal money laundering schemes by creating fictitious profits at the local subsidiary level, or, in the case of outbound shipments, to launder money by creating fictitious losses in an attempt to avoid income tax liability. Similarly, overvaluation can be indicative of income tax evasion or, in the case of imports, money laundering.

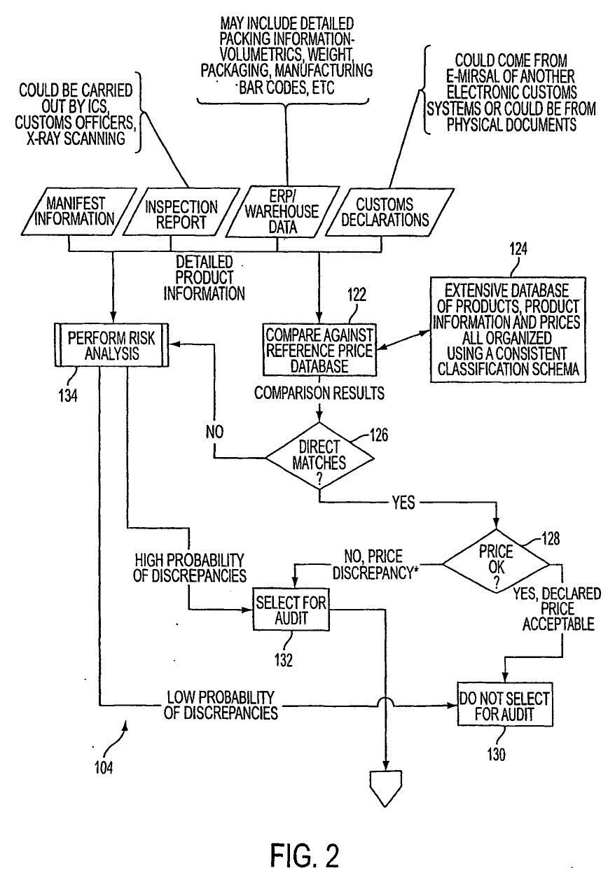

FIG. 2 illustrates in greater detail the process steps involved in selecting whether or not to select a consignment for audit at step 104. The selection process 104 includes a risk analysis performed in conjunction with a price comparison, with the results of the analysis and the comparison being combined together to arrive at a decision whether or not to select the consignment for audit. In step 122, detailed product information on the consigned items is compared against a reference price database 124 containing general price levels for a range of products. Here, “general price levels” means prices that were not necessarily obtained in compliance with Article VII guidelines. Such prices can, for example, be wholesale or distributor prices obtained from a variety of sources such as catalogs. In general, these prices tend to be higher than the export level prices obtained in accordance with the Article VII guidelines. The comparison involves searching the reference price database 124 for items matching the description of the items in the consignment. The database 124 is preferably organized using a consistent classification scheme to expedite searching. The detailed product information can come from a variety of sources including, but not limited to: the shipping manifest; inspection reports prepared by customs officials or contractors based on physical examination, x-ray scanning, etc.; ERP/warehouse data such as packing information including volumetrics, weight, packaging, manufacturing bar codes, etc.; and customs declarations.

In step 126, a decision is made whether or not there is an item in the database 124 matching the description of each declared item. If it is determined in step 126 that the database includes price information on an item matching the description of a declared item, a decision is made at step 128 whether or not there is a discrepancy between the price in the database and the declared price for the item. If there is no significant discrepancy, the declared price is deemed acceptable and the consignment is not selected for audit in step 130. If there is a price discrepancy (i.e., undervaluation or overvaluation), the product is selected for audit in step 132.

If it is decided in step 126 that there is no item in the database 124 matching the description of a declared item, a risk analysis 134 is performed using the detailed product information discussed above. The risk analysis 134, described in detail below, determines whether there is a high probability of discrepancies or a low probability of discrepancies. If the risk analysis determines that there is a high probability of discrepancies, the shipment is selected for audit in step 132. If the risk analysis determines that there is a low probability of discrepancies, the shipment is not selected for audit in step 130.

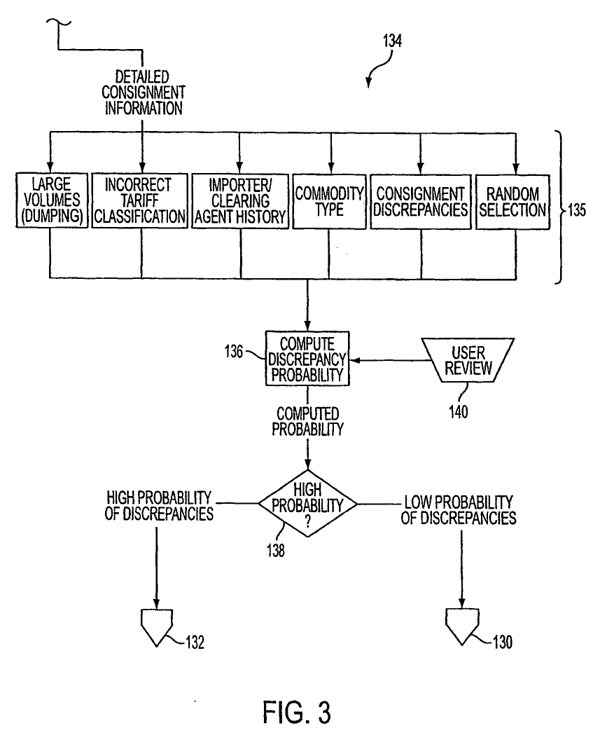

FIG. 3 illustrates in greater detail the risk analysis process 134. In step 136, a discrepancy probability is computed based upon one or more factors 135 derived from information in the consignment documents, the client's database and/or one or more of the system databases 110 and 124. Factors such as volume-weight ratio of the consignment, prior experience with a particular importer or agent, a company's tax-paying status, discrepancies in the customs documents, and commodity type can be derived from the information and flagged if they are indicative of a high probability of discrepancy. Consignments can also be selected for audit on a random basis such that random selection is a factor.

If it is determined at step 138 that the computed probability of a discrepancy is high, the shipment is selected for audit at step 132 as described above. If it is determined at step 138 that the computed probability of a discrepancy is low, the shipment is not selected for audit at step 130 as described above. The determination at step 138 can be the result of a user review at 140 or can be made automatically by the system based upon predefined rules. For example, the factors discussed above can be weighted and their sum compared against a threshold value to determine whether the probability of discrepancies is high or low.

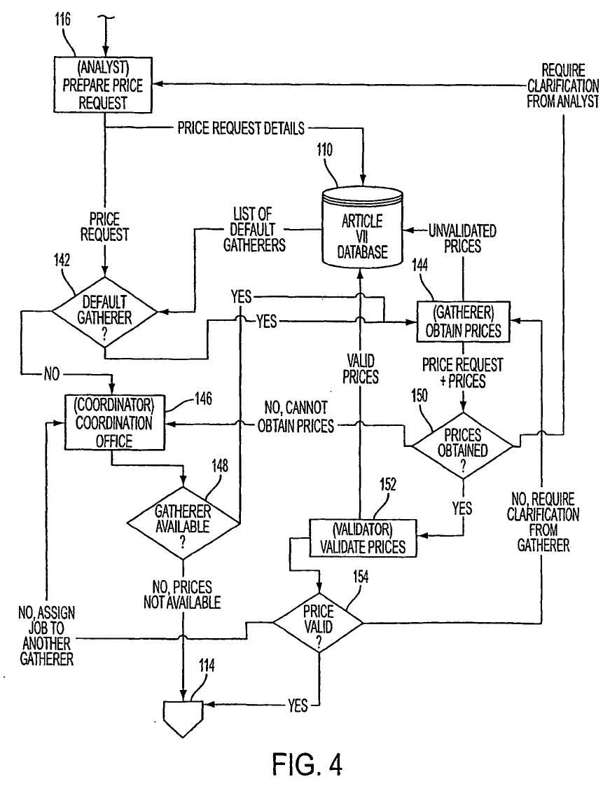

As mentioned above, if a consignment is selected for audit, a work order is prepared at step 106 and a search of the Article VII database 110 is conducted at step 108 for each type of item in the consignment. FIG. 4 illustrates details of the price gathering process 116 and 118 that occurs if it is determined at step 112 that no price is available for the selected goods on the database. In step 116, a price request is prepared for delivery to a price gatherer who will attempt to obtain price information for the specified items in accordance with the Article VII guidelines. The price request can be automatically initiated by the system following an unsuccessful search using information contained in the work order or can be manually initiated by a user (e.g., an analyst) following a search. Generally, the price request will include the same information as the work order but only for the items not in the database. The image files associated with the consignment are also preferably provided to the price gatherer.

The pricing system preferably includes a database of default price gatherers to whom price requests are automatically to be sent according to country or geographic region of interest. Alternatively, or in addition to, geographic assignment, the default price gatherers can be assigned based upon criteria such as the type of commodity being audited, etc. For purposes of illustration, the database of default price gatherers is shown as part of the Article VII database 110 in FIG. 4.

At least some details of the price request prepared in step 116 are used by the system to query the database 110 in order to obtain the name and address of a default gatherer based upon the criteria specified in the price request. If it is determined at step 142 that a default gatherer exists, the price request is sent electronically to that gatherer who will obtain the requested price at step 144. If it is determined at step 142 that a default gatherer has not been assigned, the price request is sent to a coordination office at step 146.

The coordination office makes an inquiry at step 148 to determine whether or not there is a gatherer available to handle the price request. If it is determined at step 148 that a gatherer is available, the price request is sent to that gatherer to obtain prices at step 144 as described above. If it is determined at step 148 that a suitable gatherer is not available, the process terminates without obtaining a price and returns to step 114 in FIG. 1.

Once a gatherer has received a price request, they set about obtaining the prices in accordance with the Article VII guidelines in step 144. Typically, this will involve contacting the original supplier of the item, or the supplier of a similar item, in an effort to obtain a written quote. The price gatherer responds to the price request with the prices they obtain or with notification that the prices were not obtainable. Preferably, any materials supporting a price quote are scanned into the system as image files and transmitted with the price gatherer's response. An unvalidated price can also be sent to the Article VII database. If it is determined at step 150 that the gatherer has not obtained the prices, a request can be sent to the analyst for clarification of the price request at step 116 or the price request can be sent to the coordination office for assignment to another gatherer at step 146. If it is determined at step 150 that the gatherer has obtained the prices, the gatherer's response is sent to a validator for validation at step 152. If it is determined at step 154 that the prices are not valid, a request for clarification can be sent to the gatherer for generation of a new response at step 144 if the validator does not understand the gatherer's response, or the price request can be sent to the coordination office for assignment to another gatherer at step 146. If it is determined at step 154 that the prices are valid, the prices are used to create the price audit report at step 114 in FIG. 1. The Article VII database is also preferably updated to include the prices obtained by the gatherer and validated by the validator.

As mentioned above, the price audit report is preferably presented to the client (e.g., customs officials) with physical copies of the documents associated with the consignment. Alternatively, all of the documents can be transmitted to the client electronically. The client can compare the researched prices against the declared prices and may use the price audit report to adjust the customs duty paid or payable by the declarant or, in exceptional cases, as a basis for referral to appropriate law enforcement agencies for further investigation.

The inspection and audit system using global pricing also may be used by corporate clients for price research. In such an alternate embodiment, there is no need to perform the document gathering step 102 or the audit selection step 104. The corporate client simply prepares a work order specifying the particular goods for which prices are desired, optionally along with the prices for the goods as presently quoted to the corporate client, and submits the work order. The system then searches a price reference database for the specified goods and returns found prices to the client. If the client provides quoted prices with the work order, the quoted prices can be compared with retrieved prices, such that a price research report will be returned to the client only if there is a significant discrepancy between the quoted prices submitted by the client in the work order, and the prices retrieved in the search. Otherwise, a simple confirmation can be returned to the client confirming that the quoted prices appear to conform to standard prices.

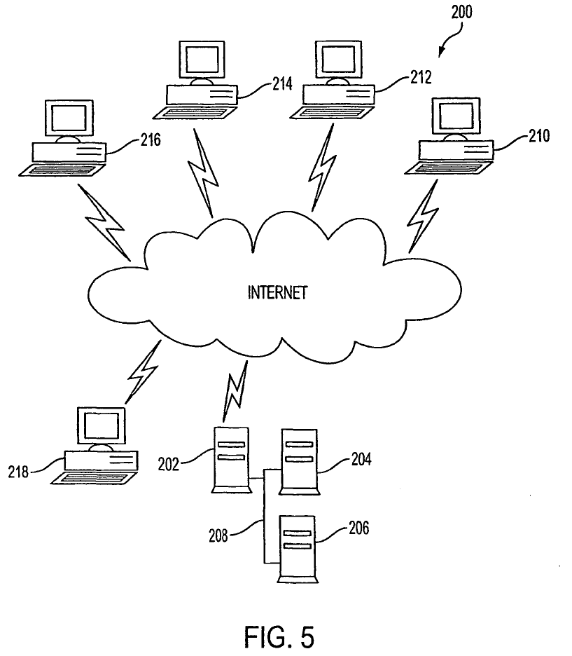

FIG. 5 is a block diagram showing an embodiment of a system 200 for implementing the global price research component 116, 118 of the customs inspection and audit process according to the present invention. The illustrated system 200 includes a web server 202, a reference price database server 204, and an Article VII database server 206 at a first site in communication with one another via a local area network 208. The web server 202 hosts a website accessible by analysts 210, price gatherers 212, validators 214, coordinators 216, and other users (e.g., management, system administrators, auditors, etc.) 218 at remote sites via the Internet 220.

In one embodiment, analysts 210 generate work orders and price requests, coordinators 216 identify price gatherers when a default gatherer has not been assigned, price gatherers 212 obtain pricing information, and validators 214 check the pricing information obtained by the price gatherers. Other users 218 can access the system for various reasons such as administering the system, and obtaining reports.

In a preferred embodiment, the website includes a home page and a number of other web pages accessible from the home page via links. Access to sensitive areas of the website can be restricted to authorized users by requiring visitors to login on the home page using a valid username and password. If the login fails, the visitor is not allowed into the sensitive areas of the website. Additional security can be obtained by use of an activities manager feature on each web page offering options to a user. The activities manager is a menu or list of available options presented to the user on each web page. The listed options provide access to other web pages and system functions based on the role of a user. The same web page can be displayed with different sets of options based on the privileges assigned to each user.

Each authorized user is preferably provided with a customized user home page that is presented when the user successfully logs into the system. Depending upon the type of user, the user home page preferably includes an “inbox”. In the case of price gatherers, the inbox can include a list of pending price requests assigned to them. In the case of analysts, the user home page can include a list of price requests that have not yet been sent to a price gatherer, completed price requests, and requests for clarification. Some examples of the types of information that can be displayed include the reference number of a specific price request, the work order number, the due date for a specific price request, the current status of the price request, the last time work has been done on a particular price request, the identity of the first person who started working on that specific price request, and the specific date when that price request was sent. Preferably, users can click on a listed price request to obtain additional details such as item descriptions.

Preferably, items in the price request can also be individually selected by a user to view additional details. If the user is an analyst, the system can offer options allowing the analyst to submit a price request to their team leader or a coordinator/gatherer, or to close the work order once a price is obtained.

The website preferably includes a page displaying information about the user such as their first and last names, any other names they use, their phone number, their facsimile number, and their e-mail address. An option may be offered allowing the user to change the information in their profile. They may also be presented with an option to change their username or password.

The website also preferably includes a page for generating reports. In the case of an analyst, for example, an option is preferably presented allowing the analyst to view their performance report, which includes the percentages of price requests received and sent for specific periods of time, the average number of days it took to process a price request, the average number of days a price request is due from the date received, and the average number of days a price request is due from the date it was sent out for price gathering. Due to the flexible nature of the system, new reports can be added as needed. Some reports can be designed to allow the data to be “drilled-down”, i.e., similar to how a pivot table operates, so that reports can be generated with any level of detail.

The website preferably further includes a webpage allowing authorized users to add a reference price to the system as well as to search for prices using a simple criteria or an advanced criteria depending upon how many details are available about the item. For example, the user may conduct a simple search to see if there are any items in one of the databases that match the description in the work order. This typically involves entering a keyword (e.g., refrigerator, computer, etc.) in a search window and submitting the search criteria. If a large number of prices are returned, the user can conduct a more specific search by inserting more details about the product.

When adding a reference price to a database, the user is preferably prompted for information such as the source name and the type of source (e.g., written quotation from the original seller, written quotation from a different seller, export price list, etc.); the product name with a good description of the product; the make, model, serial number, UPC/EAN code, packing type, state, origin, and year of manufacture (when available); the HS-code, quantity of the product, the unit of measurement (e.g., pieces, kg, etc.), the unit price for the product, the currency of the unit price and the exchange rate. The user may then check if the price is an Incoterm price and, if so, what type and the name of the country of reference.

The system will also preferably allow users (in particular, analysts) to create new work orders, search for an existing work order by number, view and manage importers/clearing agents, and view and manage exporters. When creating a work order, the user is preferably asked to provide a reference number and date of selection for audit and to identify the client country. Once this data is entered, the system shows any existing information corresponding to the work order and provides options to the user allowing them to edit the work order details, insert/edit consignment details, enter a new audit item for the work order, create a price request, or return to the previous page. Consignment information may include the country from which the goods are shipped, the final destination, and the mode of transport. The product description may include the product name, a typed description of the product, make, model, serial number, UPC/EAN code, packing type, state, origin and year of manufacture. Product pricing information may include HS-code, quantity, unit price, and the currency in which the price is given. If necessary, the system can convert the amount to U.S. dollars and display the converted price on the screen.

The system is preferably configured so that it can be remotely administered using a standard browser interface. Management of users, roles, teams, data tables and workflows is preferably possible given sufficient privileges within the system. For example, a first page can show a list of teams currently on the system. Clicking on a team name brings up a list of activities that can be performed, such as editing the details entered for the team, deleting the team, viewing the current members of the team, managing users in the team by assigning and/or removing users.

The system preferably also provides management with tools that inform of any possible bottlenecks caused by users (i.e., too many requests in one inbox) or under-utilization of resources (i.e., too few price requests per user).

When the user is required to enter certain information, the system will preferably provide drop-down or pop-up lists to assist the user in selecting the appropriate information.

An advantage to implementing the pricing system over the Internet is that users only need a browser and an Internet connection to access the system. No other software is required to be installed on a user's computer system. In addition, all product enhancements are immediately made available to the user as they occur without the need to update any software on the user's computer system. Furthermore, such an implementation allows the data to be handled in a conventional format, such as XML, so that it can be exported to other solutions if needed.

While the invention has been described in detail above, the invention is not intended to be limited to the specific embodiments as described. It is evident that those skilled in the art may now make numerous uses and modifications of and departures from the specific embodiments described herein without departing from the inventive concepts. For example, the online global pricing system can be used alone or with other inspection and auditing processes. The global pricing system can be implemented over any type of distributed network including, but not limited to, the Internet, a wide area network, a local area network, or any combination of the foregoing. Separate database servers can be used for the Article VII and reference databases or a single database server can be used for both databases. The web server and database servers can be co-located as shown or these system components can be located at different sites connected to one another via the network. Information other than that described above can be included in a work order, a pricing request, or a price audit report used in a customs inspection and auditing process according to the present invention. A work order can be submitted by filling out a form on a website hosted by the system, by e-mailing a form to the system over the network, by computer facsimile transmission, or by any other manner of electronic transmission. If necessary, a hard copy of the work order can be submitted to a system operator via mail, facsimile transmission or some other type of physical delivery for manual entry into the system.

1. A computer-implemented method for determining valuation of a consignment of goods, comprising the steps of:
receiving information pertaining to said consignment, including identification of specific goods in said consignment, and predetermined parameters of said consignment;
determining whether or not to select said consignment for audit by applying predefined criteria to said received information, comparing a result of the criteria application with a predefined threshold value, and indicating whether said consignment is selected for audit based on the result of the comparison;
receiving a work order for a consignment selected for audit, said work order identifying the goods in the consignment in a manner sufficient to enable pricing information to be retrieved for said goods;
generating a search query to a global pricing database containing global export level pricing of goods in accordance with said work order;
receiving export level prices of goods in response to said search query; and
generating a price audit report based on said received export level prices.

2. The computer-implemented method of claim 1, wherein said information pertaining to said consignment includes information obtained from a manifest document.

3. The computer-implemented method of claim 1, wherein said information pertaining to said consignment includes information obtained from a shipping invoice.

4. The computer-implemented method of claim 1, wherein said information pertaining to said consignment includes information obtained from a customs declaration.

5. The computer-implemented method of claim 1, wherein said information pertaining to said consignment includes information obtained from a customs inspection report.

6. The computer-implemented method of claim 1, wherein the step of determining whether or not to select said consignment for audit includes the step of performing a risk analysis of said received information, and said predefined criteria is selected from the group consisting of the volume of the consignment, incorrect tariff classification, importer/clearing agent history, commodity type, consignment discrepancies, and random selection.

7. The computer-implemented method of claim 1, wherein the step of determining whether or not to select said consignment for audit includes the step of comparing price information in said received information with price information retrieved from a reference price database, and said predefined criteria defines an amount by which retrieved price information from said reference price database is different from price information in said received information.

8. The computer-implemented method of claim 1, further comprising the step of submitting a price request for a product in said selected consignment to a price gatherer when said search query to a global pricing database fails to retrieve a price for that product.

9. The computer-implemented method of claim 8, further comprising the step of selecting a price gatherer from a stored list of price gatherers, according to specific received information pertaining to said consignment.

10. The computer-implemented method of claim 9, wherein said specific received information includes a geographic region of interest with respect to said product in said selected consignment.

11. The computer-implemented method of claim 1, wherein said work order includes a digital image of products in said consignment, said digital image being associated with product identification information.

12. The computer-implemented method of claim 1, wherein identification information in said work order is obtained by scanning a bar code associated with said consignment.

13. A system for determining valuation of a consignment of goods, comprising:
a server connected to a communication network, said server receiving information pertaining to said consignment, including identification of specific goods in said consignment, and predetermined parameters of said consignment;
said server including program instructions that determine whether or not to select said consignment for audit by applying predefined criteria to said received information, compare a result of the criteria application with a predefined threshold value, and indicate to a user on said network whether said consignment is selected for audit based on the result of the comparison;
said server receiving from said user a work order for a consignment selected for audit, said work order identifying the goods in the consignment in a manner sufficient to enable pricing information to be retrieved for said goods;
a global pricing database containing global export level pricing of goods, said database receiving a search query in accordance with said work order, and sending export level prices of goods to said server in response to said search query; and
wherein said server generates a price audit report based on said received export level prices and sends said report to said user over said network.

14. The system of claim 13, wherein said information pertaining to said consignment includes information obtained from a manifest document.

15. The system of claim 13, wherein said information pertaining to said consignment includes information obtained from a shipping invoice.

16. The system of claim 13, wherein said information pertaining to said consignment includes information obtained from a customs declaration.

17. The system of claim 13, wherein said information pertaining to said consignment includes information obtained from a customs inspection report.

18. The system of claim 13, wherein said program instructions cause said server to perform a risk analysis of said received information, and said predefined criteria is selected from the group consisting of the volume of the consignment, incorrect tariff classification, importer/clearing agent history, commodity type, consignment discrepancies, and random selection.

19. The system of claim 13, wherein said program instructions cause said server to compare price information in said received information with price information retrieved from a reference price database, and said predefined criteria defines an amount by which retrieved price information from said reference price database is different from price information in said received information.

20. The system of claim 13, wherein said work order includes a digital image of products in said consignment, said digital image being associated with product identification information.

21. A system for determining valuation of goods, comprising:
a server connected to a communication network, said server receiving from a user over said network a work order containing information pertaining to said goods, including identification of specific goods in a manner sufficient to enable pricing information to be retrieved for said goods; and
a global pricing database connected to said communication network, containing global pricing of goods, said database receiving a search query in accordance with said work order, and sending corresponding global prices of goods to said server in response to said search query;
wherein said server generates a price research report based on said received global prices and sends said report to said user over said network.
